(19) United States
(12) Patent Application Publication
(10) Pub. No.: US 2024/0185150 A1
(43) Pub. Date: Jun. 6, 2024

(54) Two-stage stochastic programming based V2G scheduling model for operator revenue maximization

(71) Applicant: GUANGZHOU INSTITUTE OF ENERGY CONVERSION, CHINESE ACADEMY OF SCIENCES, Guangzhou (CN)

(72) Inventors: Yuping Huang, Guangzhou (CN); Chen Hu, Guangzhou (CN)

(73) Assignee: GUANGZHOU INSTITUTE OF ENERGY CONVERSION, CHINESE ACADEMY OF SCIENCES, Guangzhou (CN)

(21) Appl. No.: 18/282,413

(22) PCT Filed: Apr. 22, 2021
(86) PCT No.: PCT/CN2021/088841

§ 371 Date: Dec. 21, 2023

(30) Foreign Application Priority Data
Mar. 16, 2021 (CN) 202110282253.2

(51) Int. Cl. G06Q 10/0631; G06Q 50/06

(52) U.S. Cl. CPC G06Q 10/06315; G06Q 50/06

(57) ABSTRACT

A two-stage stochastic programming based V2G scheduling for operator revenue maximization is provided. Said method aims for the charge/discharge scheduling of electric vehicles, and establishes, based on a distributed renewable energy-storage-EVs charge/discharge power system, a V2G two-stage nonlinear stochastic programming model combining the V2G scheduling randomness with the renewable energy power generation randomness. Said model is converted into a mixed integer linear programming model (MILP) by means of constraint linearization. Furthermore, in order to enable random scenarios to cover uncertainty factors comprehensively, a scenario generation and combination method is designed to combine the V2G scheduling resources with the randomness of the renewable energy level. The V2G two-stage stochastic programming model solves an optimal charge/discharge plan of the electric vehicles seeking to adapt the randomness of the V2G scheduling layer and the renewable energy randomness, and increases the revenue of said model participating in power assistance services.

### CROSS REFERENCE TO RELATED APPLICATION

This patent application is a national stage of International Application No. PCT/CN2021/088841, filed on Apr. 22, 2021, which claims the benefit and priority of Chinese Patent Application No. 202110282253.2 filed with the China National Intellectual Property Administration on Mar. 16, 2021, both of the aforementioned applications are incorporated by reference herein in their entireties as part of the present application.

### TECHNICAL FIELD

The present disclosure relates to the field of energy management and optimization models, and in particular, to a two-stage stochastic programming based V2G scheduling method for operator revenue maximization.

### BACKGROUND

Vehicle-to-Grid (V2G) is designed for interaction between an electric vehicle and a power grid. A battery of the electric vehicle is used as a buffer for the power grid and renewable energy. In the external environment of energy conservation and emission reduction, and fossil energy shortage, electric vehicles (EVs) have gradually occupied more market shares of fuel vehicles for their low use cost and prominent energy conservation and environmental protection effects. In addition to energy conservation and emission reduction, EVs, as mobile energy storage, can bring many auxiliary services for the power grid by vehicle-grid interaction, including auxiliary peak regulation and auxiliary frequency modulation for the power grid. This model can realize peak regulation, accurately control charging and discharging states and capacities of EVs, so that EVs are orderly involved in operation regulation of the power grid. When EVs are involved in the operation regulation of the power grid, centralized scheduling of a V2G operator (a scheduling center) plays an indispensable role.

The V2G operator is the revenue subject of the model and is responsible for managing charging and discharging of in-agreement EVs and providing power for out-of-agreement EVs, operating a renewable energy power generation system within the area, providing power transfer for part of loads within the area and feeding surplus power from the area into the power grid.

The problem of EVs involved in V2G charging and discharging scheduling is an optimal decision problem with multiple uncertainties, which may be divided into the randomness of V2G scheduling resource and the randomness of renewable energy power generation. In previous studies, it is difficult to comprehensively consider the co-effects of randomness of EVs involved in the V2G, and combination of the V2G scheduling resource randomness and the renewable energy randomness is not deeply studied.

### SUMMARY

In view of deficiency in the prior art, the present disclosure provides a two-stage stochastic programming based V2G scheduling method for operator revenue maximization. This V2G two-stage nonlinear stochastic programming model integrates V2G scheduling randomness and renewable energy power generation randomness, which in particular considers V2G scheduling resource randomness and the renewable energy randomness.

In order to achieve the above objective, the present disclosure adopts the following technical solutions.

A two-stage stochastic programming-based V2G scheduling method is provided, which aims at maximizing operator revenue for a system including electric vehicles (EVs), charging and discharging stations, and a power grid. The method includes the following steps:

obtaining a day-ahead parameter set of EVs within the operator's service area, issuing scheduling invitation agreements to EVs within the service area, classifying EVs accepting the scheduling invitation agreements as in-agreement EVs, and EVs not responding or refusing the agreements as out-of-agreement EVs;

establishing a random scenario set based on the day-ahead parameter set of EVs within the service area, conditions of in-agreement and out-of-agreement EVs, and renewable energy generation, and given that a predetermined random charging demand for the out-of-agreement EVs is met, optimal charging and discharging scheduling of the in-agreement EVs is performed;

in consideration of independence of random factors, determining a final random scenario by using a random scenario set model, and establishing a V2G two-stage nonlinear stochastic programming model based on the final random scenario; and

maximizing a total revenue of a V2G operator by using the V2G two-stage nonlinear stochastic programming model.

Compared with the prior art, the present disclosure has the following beneficial effects:

In full consideration of the stochastic nature of both V2G scheduling resources and renewable energy power generation, a two-stage stochastic programming model is established to maximize operator revenue. This model effectively enhances the V2G scheduling process by specifying and quantifying expected revenue of a V2G scheduling system, comprehensively optimizing operating states of in-agreement EVs involved in V2G scheduling, and providing theoretical and methodological support for optimal utilization and modeling of vehicle-grid interaction resources.

In light of diverse random factors influencing EVs, an enhanced scenario generation method for V2G scheduling resource randomness and renewable energy power generation randomness is developed. This improvement ensures that the scenario sets of the two-stage stochastic programming model comprehensively capture multiple sources of randomness.

### BRIEF DESCRIPTION OF THE DRAWINGS

To describe the technical solutions in the embodiments of the present disclosure more clearly, the accompanying drawings required in the embodiments are briefly described below. Apparently, the accompanying drawings described below are only some embodiments of the present disclosure. For those of ordinary skill in the art, other accompanying drawings may be obtained from these accompanying drawings without creative efforts.

FIG. 1 is a flowchart of a V2G scheduling method in an embodiment of the present disclosure;

FIG. 2 is a diagram illustrating a revenue-cost relationship of a V2G operator in an embodiment of the present disclosure;

FIG. 3 is a schematic diagram of a scenario generation process of a V2G optimized scheduling model considering randomness in an embodiment of the present disclosure;

FIG. 4 is a distribution diagram of network nodes of a V2G operator in an embodiment of the present disclosure;

FIG. 5 is a diagram of EVs decision variables in an embodiment of the present disclosure; and

FIG. 6 is a histogram of charging and discharging loads of EVs in a scenario in an embodiment of the present disclosure.

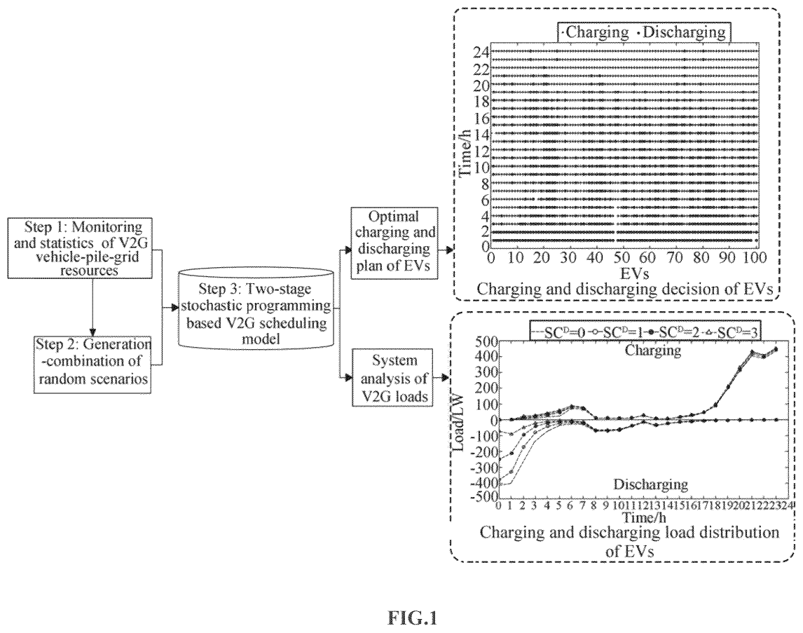

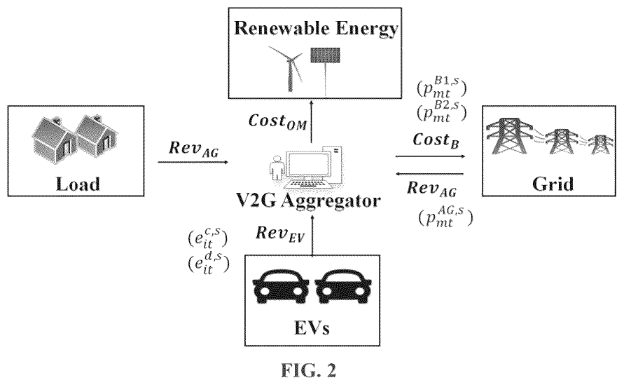

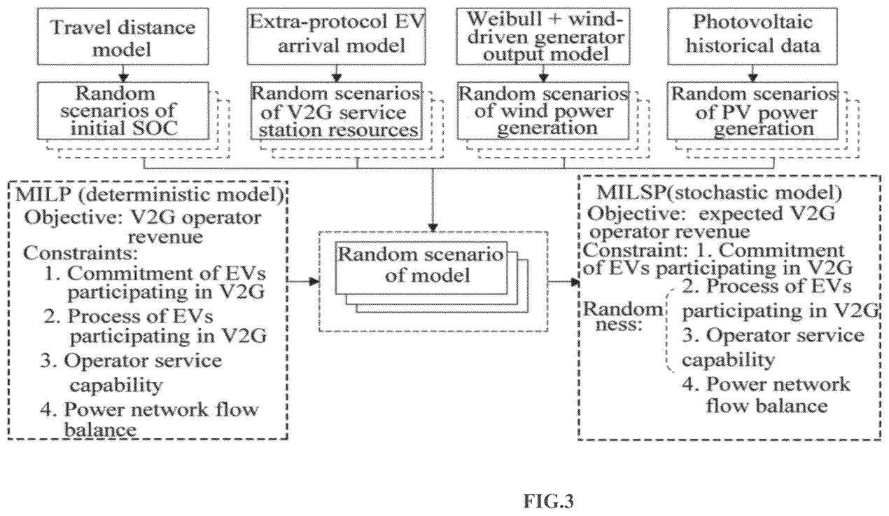

### DETAILED DESCRIPTION OF THE EMBODIMENTS

The technical solutions in the embodiments of the present disclosure are described below clearly and completely with reference to the accompanying drawings in the embodiments of the present disclosure. Apparently, the described embodiments are merely some rather than all of the embodiments of the present disclosure. All other embodiments derived from the embodiments of the present disclosure by those of ordinary skill in the art without creative efforts should fall within the protection scope of the present disclosure.

Embodiments:

It should be noted that the terms “include”, “comprise”, and any variants thereof in the embodiments of the present disclosure are intended to cover non-exclusive inclusion. For example, a process, method, system, product or device that includes a series of steps or units is not necessarily limited to those steps or units which are clearly listed, but may include other steps or units which are not clearly listed or inherent to the process, method, product or device.

In a specific embodiment, the present disclosure may include the following steps.

In step 1, V2G vehicle-pile-grid resources are monitored and counted.

EVs and capacities of service stations within a service area of a V2G operator are counted and analyzed to establish a random scenario set.

1. Day-ahead parameters (a vehicle model, a battery capacity, a battery power, expected parking position, charging and discharging climbing capabilities, etc.) of EVs involved in scheduling are obtained by means of vehicle-pile-grid information interaction and real-time data updating.

2. According to results of users responding to a V2G scheduling invitation of the power grid, EVs agreeing with being involved in day-ahead scheduling are classified as in-agreement EVs and those not responding to or refusing the invitation as out-of-agreement EVs.

3. In-agreement EVs: EVs agreeing with being involved in scheduling are arranged at charging and discharging stations managed by the operator according to a distance priority principle, connected to the grid before a specified time, and responded to charging, discharging, grid connection, and grid disconnection instructions from a scheduling center in real time.

4. Out-of-agreement EVs: an EV charging demand is given or generated randomly and met in priority by the scheduling center. Such a charging demand is not controlled by the scheduling center.

In step 2, random scenarios are generated and combined.

The V2G operator generates a random scenario by a scenario generation-combination method, and the random scenario is applied to the second-stage constraints of a V2G scheduling mathematical model. When random charging demands of out-of-agreement EVs are met, an optimal charging and discharging scheduling of the in-agreement EVs are performed.

### 2-1. Random Scenarios of V2G Scheduling Resources

The random scenarios of V2G scheduling resources mainly include a random scenario of initial SOCs of EVs and a random scenario of V2G service station resources.

To embody the SOC randomness of the in-agreement EVs involved in scheduling, a logarithm normal distribution model (1) of day-ahead travel distances of the in-agreement EVs is used; travel distances of the in-agreement EVs before grid connection are obtained by a Monte Carlo method with a random parameter Dᵢ^{s} of the travel distance, and a random scenario set SC^{D} is generated correspondingly.

$${f}_{d} ( d ) = \frac{8}{5 d {σ}_{d} \sqrt{2 π}} exp \{ - \frac{{[ ln ( 5 d ) - 3 ln 2 - {μ}_{d} ]}^{2}}{2 {σ}_{d}^{2}} \} \qquad ( 1 )$$

To present the randomness of EV schedulable resources (schedulable capacity) of EVs charging and discharging stations, a homogeneous Poisson model (2) with a constant average arrival rate is selected to describe the number of out-of-agreement EVs randomly arriving; the number of out-of-agreement EVs randomly arriving at the charging and discharging stations is obtained by the Monte Carlo method as a random parameter Zₘ^{s,t} of arrival number; and a random scenario set SC^{Z} is correspondingly generated.

$$P ( i ) = \frac{{λ}^{i} {e}^{- λ}}{i !} , ∀ i ∈ {I}_{z} , and i ∉ I \qquad ( 2 )$$

### 2-2. Random Scenario of Renewable Energy Power Generation

A random parameter of wind speed is obtained by Latin hypercube sampling (LHS) according to Formula (3) of Weibull distribution of wind power generation.

$$\\ \begin{matrix}Pv ( v , k , c ) = ( k / c ) * {( v / c )}^{{}^{} k - 1} {e}^{- {( \frac{v}{c} )}^{{}^{} k - 1}} & ( 3 )\end{matrix}$$

The number of scenarios is reduced by a simultaneous backward reduction method, and a scenario SC^{WT} of wind power output is generated by a wind-driven generator power fitting model.

In terms of photovoltaic power generation simulation, historical data of daily photovoltaic power generation for one year is selected to generate a scenario pool of photovoltaic power generation; the random scenario of photovoltaic power generation is obtained by random sampling; and a random scenario SC^{PV} is generated by the simultaneous backward reduction method.

### 2-3. Combination of Random Scenarios

In consideration of the random factors being independent of one another, the four random scenarios (SC^{D}, SC^{Z}, SC^{WT}, SC^{PV}) are combined and calculated based on formula (4). The random scenarios are cross-combined to generate a final random scenario SC^{F} of the model. Formula (4) is used to calculate a probability of a scenario combination SC^{F}.

$$\begin{matrix}P ( s ) = P ( {sc}^{D} ) P ( {sc}^{Z} ) P ( {sc}^{PV} ) P ( {sc}^{WT} ) & ∀ s ∈ {SC}^{F} , {sc}^{D} ∈ {SC}^{D} , {sc}^{Z} \\ & ∈ {SC}^{Z} , {sc}^{PV} \\ & ∈ {SC}^{PVB} , {sc}^{WT} \\ & ∈ {SC}^{WT}\end{matrix} \qquad ( 4 )$$

where P(sc^{D}) is 1/SC^{D}, P(sc^{z}) is 1/SC^{Z}; and P(sc^{PV}) and P(sc^{WT}) are determined by the scenario reduction algorithm.

In step 3, a V2G two-stage nonlinear stochastic programming model is established.

First, variables of the EV scheduling process of EVs are defined, and variables of energy supply to a regional power grid are defined. A revenue framework of the V2G operator is then built, and subsequently, and two-stage constraints are established and linearized.

Tables 1 to 3 list parameters and variables of the V2G two-stage nonlinear stochastic programming model, respectively, as follow.

TABLE 1
Indexes and Sets

| Symbol | Definition |
|---|---|
| m | Network node, m ∈ M |
| i | In-service agreement EVs, i ∈ I_{z} represents |
| | the out-of-agreement EVs. |
| t | Schedulable time period, t ∈ T |
| s | system scenario, s ∈ SC^{F} |
| SC^{F} | Final scenario set |
| SC^{D} | Scenario set for random travel distances |
| | of EVs before they are scheduled |
| SC^{Z} | Scenario set for randomness of the real- |
| | time number of the out-of-agreement EVs |
| SC^{WT} | Scenario set for randomness of wind power |
| | generation |
| SC^{PV} | Scenario set for randomness of photovoltaic |
| | power generation |

TABLE 2
Parameters of a Scheduling Model

| Symbol | Definition |
|---|---|
| Prob^{s} | Probability of scenario s |
| Dᵢ^{s} | Distance (km) traveled by EVᵢ |
| | before grid connection in scenario s |
| zₘₜ^{s} | Real-time number of out-of-scheduling |
| | agreement EVs within time period t at |
| | node m in scenario s |
| ESᵢ | Power consumed by EVᵢ per 100 km |
| | (kwh/100 km) |
| αₘ, βₘ | Maximum numbers of EVs available for |
| | charging and discharging at node m, |
| | respectively |
| Pliesₘ | Total number of V2G service piles at |
| | node m |
| pₘₜ^{r, s} | Renewable energy power generation (kwh) |
| | in the period t at node m in scenario s |
| pₘₜ^{WT, s} | Wind power generation output (kwh) in the |
| | time period t at node m in scenario s |
| Pₘₜ^{PV, s} | Photovoltaic power generation output (kwh) |
| | in the time period t at node m in scenario s |
| pₘₜ^{load, s} | Conventional load demand (kwh) within |
| | time period t at node m in scenario s |
| Priceₜ^{c}, Priceₜ^{d} | Charging unit price and discharging unit |
| | price (Yuan/kwh) of EVs within time period |
| | t, respectively |
| pₘ^{gmax} | Maximum thermal power generation capacity |
| | at node m |
| Cₜ^{AG} | Power price (Yuan/kwh) at which the operator |
| | sells surplus power to the power grid |
| Cₜ^{AG1}, Cₜ^{AG2} | Power prices (Yuan/kwh) at which the operator |
| | purchases thermal power at first and second |
| | stages, respectively |
| C^{r} | Renewable energy power generation cost (Yuan/ |
| | kwh) at node m |
| CSᵢ, DSᵢ | Fixed service fees (Yuan) of charging and |
| | discharging of EVᵢ, respectively |
| Lᵢ^{c}, Lᵢ^{d} | Least durations of EVᵢ continuous |
| | charging and discharging (h), respectively |
| Lᵢ^{idle} | Least idle durations after EVᵢ continuous |
| | charging and discharging (h) |
| Nᵢ^{c}, Nᵢ^{d} | Upper limits of charging times and discharging |
| | times of EVᵢ within a service cycle, respectively |
| Vᵢ | Upper limit of charging-discharging switching |
| | times of EVᵢ within a service cycle |
| SOCᵢ^{max}, SOCᵢ^{min} | Physical upper limit and lower limit (%) of |
| | SOC of EVᵢ, respectively |
| SOCᵢ^{umax}, SOCᵢ^{umin} | Expected maximum and minimum SOCs (%) of |
| | EVᵢ on departure, respectively |
| Capᵢ | Battery capacity (kwh) of EVᵢ |
| Kᵢ^{c}, Kᵢ^{d} | Maximum charging and discharging capacities |
| | (kwh) of EVᵢ per hour, respectively |
| Eₘₜ^{c, s} | Maximum charging capacity (kwh) of V2G |
| | scheduling within time period t at node m in |
| | scenario s |
| P_{NonV2G}^{c} | Charging power (kw) of V2G out-of-agreement |
| | EVs |
| Eₘₜ^{cNonV2G, s} | Charging capacity of V2G out-of-agreement EVs |
| | within time period t at node m in scenario s |
| Line.Capₗ | Power capacity (kwh) of a power grid line |

TABLE 3
Model Variables

| Symbol | Definition |
|---|---|
| μᵢₜ^{c} | State of EVᵢ within time period t, μᵢₜ^{c} ∈ {0, 1} |
| | μᵢₜ^{c} = 1 represents a charging state, and |
| | μᵢₜ^{c} = 0 represents an idle state when |
| | charging is stopped |
| μᵢₜ^{d} | State of EVᵢ within time period t, μᵢₜ^{d} ∈ {0, 1} |
| | μᵢₜ^{d} = 1 represents a discharging state, and |
| | μᵢₜ^{d} = 0 represents an idle state when |
| | discharging is stopped |
| νᵢₜ^{c} | Switching operation of EVᵢ from idle to charging within |
| | time period t, νᵢₜ^{c} ∈ {0, 1} |
| νᵢₜ^{d} | Switching operation of EVᵢ from idle to discharging within |
| | time period t, νᵢₜ^{d} ∈ {0, 1} |
| wᵢₜ^{c} | Operating state of EVi switching from charging to idle within time period |
| | t, wᵢₜ^{c} ∈ {0, 1} |
| wᵢₜ^{d} | Operating state of EV¿ switching from discharging to idle |
| | within time period t, wᵢₜ^{d} ∈ {0, 1} |
| eᵢₜ^{c, s}, eᵢₜ^{d, s} | Charging and discharging capacities (kwh) of EVᵢ |
| | within time period t in scenario s |
| eᵢₜ^{s} | Power state (kwh) of EVᵢ within time period t |
| | in scenario s |
| sᵢₜ^{s} | SOC (%) of EVᵢ within time period t in scenario s |
| fₗₜ^{in, s}, fₗₜ^{out, s} | Input and output power (kwh) at a power grid node within time |
| | period t in scenario s |
| pₘₜ^{AG, s} | Surplus power (kwh) at V2G node m flow into the grid within |
| | time period t in scenario s |
| pₘₜ^{B1, s} | Thermal power with long-term agreement (kwh) at V2G node m |
| | within time period t in scenario s, at a power price of Cₜ^{AG1} |
| pₘₜ^{B2, s} | Real-time procurement of thermal power (kwh) at V2G node m |
| | within time period t in scenario s, at a power price of Cₜ^{AG2} |

### 3-1. Objective Function

An objective equation F is constructed to maximize the total revenue of the V2G operators, as shown in formula (5). Formula (6) represents a total revenue (Reν_{EV}) of the operator for scheduling EVs; formula (7) represents a total revenue (Reν_{AG}) of the operator for coordinating power supply, local loads and surplus power fed into the grid; formula (8) represents a total cost (Cost_{B}) of the operator for purchasing thermal power on the day ahead and the current day; and formula (9) represents a total cost (Cost_{OM}) of renewable energy power generation governed of the operator.

$$\\ \begin{matrix}Max F = {\sum }_{i ∈ I} {\sum }_{t ∈ {T}_{i}} ( {CS}_{i} {v}_{it}^{{}^{} c} + {DS}_{i} {v}_{it}^{{}^{} d} ) + {\sum }_{s ∈ S} {Prob}^{{}^{} s} [ ( {Rev}_{EV} + {Rev}_{AG} - {Cost}_{B} - {Cost}_{OM} ) ] & ( 5 )\end{matrix}$$

$$\\ \begin{matrix}where : {Rev}_{EV} = {\sum }_{i ∈ I} {\sum }_{t ∈ {T}_{i}} ( {Price}_{t}^{{}^{} c} {e}_{it}^{{}^{} c , s} - {Price}_{t}^{{}^{} d} {e}_{it}^{{}^{} d , s} ) Δ t & ( 6 )\end{matrix}$$

$$\\ \begin{matrix}{Rev}_{AG} = {\sum }_{m ∈ M} {\sum }_{t ∈ {T}_{i}} ( {C}_{t}^{{}^{} AG} {p}_{mt}^{{}^{} AG , s} ) Δ t + {\sum }_{m ∈ M} {\sum }_{t ∈ {T}_{i}} ( {C}_{t}^{{}^{} AG 1} {P}_{mt}^{{}^{} load , s} ) Δ t & ( 7 )\end{matrix}$$

$$\\ \begin{matrix}{Cost}_{B} = {\sum }_{m ∈ M} {\sum }_{t ∈ {T}_{i}} ( {C}_{t}^{{}^{} AG 1} {p}_{mt}^{{}^{} B 1 , s} + {C}_{t}^{{}^{} AG 2} {p}_{mt}^{{}^{} B 2 , s} ) Δ t & ( 8 )\end{matrix}$$

$$\\ \begin{matrix}{Cost}_{OM} = {\sum }_{m ∈ M} {\sum }_{t ∈ {T}_{i}} ( {C}^{{}^{} r} {P}_{mt}^{{}^{} r , s} ) Δ t & ( 9 )\end{matrix}$$

First-stage constraints:

Formula (10) represents a repulsive constraint on charging and discharging of EVs: a charging operation and a discharging operation of the same EV cannot occur at the same time within a scheduling time period.

μᵢₜ^{c}+μᵢₜ^{d}≤1∀i∈I, t∈T (10)

Formulas (11-14) represent constraints on charging state of EVs. An EV is connected to a power distribution network to be charged within a time period t, in order to limit a least charging duration and a least idle duration and avoid frequent switching among charging, discharging, and idle states, thereby preventing battery damage of the EV and a cost increase in service switching, where Lᵢ^{c} represents the least charging duration, and Lᵢ^{idle} represents the least idle duration.

μᵢₜ^{c}−μᵢₜ₋₁^{c}≤μ_{iτ}^{c}∀i∈I, t∈T, τ=tᵢ, . . . , min{tᵢ+Lᵢ^{c}−1, |T|} (11)

μᵢₜ₋₁^{c}−μᵢₜ^{c}≤1−μ_{iτ}^{c}∀i∈I, t∈T, τ=tᵢ, . . . , min{tᵢ+Lᵢ^{idle}−1, |T|} (12)

vᵢₜ^{c}≥μᵢₜ^{c}−μᵢₜ₋₁^{c}∀i∈I, t∈T (13)

wᵢₜ^{c}≥−μᵢₜ^{c}+μᵢₜ₋₁^{c}∀i∈I, t∈T (14)

Formulas (15-18) represent constraints on discharging states of EVs to limit a shortest discharging duration and a shortest idle duration, where Lᵢ^{d} represents the shortest discharging duration;

μᵢₜ^{d}−μᵢₜ₋₁^{d}≤μ_{iτ}^{d}∀i∈I, t∈T, τ=tᵢ, . . . , min{tᵢ+Lᵢ^{d}−1, |T|} (15)

μᵢₜ₋₁^{d}−μᵢₜ^{d}≤1−μ_{iτ}^{d}∀∀i∈I, t∈T, τ=tᵢ, . . . , min{tᵢ+Lᵢ^{idle}−1, |T|} (16)

vᵢₜ^{d}≥μᵢₜ^{d}−μᵢₜ₋₁^{d}∀i∈I, t∈T (17)

wᵢₜ^{d}≥−μᵢₜ^{d}+μᵢₜ₋₁^{d}∀i∈I, t∈T (18)

Formulas (19-21) serve as constraints on the maximum number of charging and discharging switching times for EVs, thereby imposing limits on the frequency of these activities within a single day. By restricting the maximum number of switchable states of an EV in a day, these constraints effectively prevent excessively frequent transitions between charging and discharging states. Hence, Nᵢ^{c} and Nᵢ^{d} denote upper limits of charging times and discharging times of a single EV in a V2G scheduling plan, restrictively, while Vᵢ represents an upper limit of charging and discharging switching times.

$$\\ \begin{matrix}{\sum }_{t ∈ {T}_{i}} {v}_{it}^{{}^{} c} \leq {N}_{i}^{{}^{} c} ∀ i ∈ I , t ∈ T & ( 19 )\end{matrix}$$

$$\\ \begin{matrix}{\sum }_{t ∈ {T}_{i}} {v}_{it}^{{}^{} d} \leq {N}_{i}^{{}^{} d} ∀ i ∈ I , t ∈ T & ( 20 )\end{matrix}$$

$$\\ \begin{matrix}{\sum }_{t ∈ {T}_{i}} {v}_{it}^{{}^{} c} + {\sum }_{t ∈ {T}_{i}} {v}_{it}^{{}^{} d} \leq {V}_{i} ∀ i ∈ I , t ∈ T & ( 21 )\end{matrix}$$

Second-stage constraints:

Formulas (22-23) represent initial state constraints of EVs during grid connection. Formula (22) is used to calculate an initial power of an EV during grid connection, based on a travel distance of the EV before grid connection and participating in scheduling; formula (23) is used to calculate an initial SOC of EV A . The randomness of the travel distance results in the randomness of initial SOCs of an EV cluster. Dᵢ^{s} represents a random parameter of the travel distance of in-agreement EV 1 before grid connection.

eᵢₜ^{s}=Capᵢ−Dᵢ^{s}Esᵢ/100∀t=0, i∈I, s∈S (22)

sᵢₜ^{s}=e_{i,t}^{s}/Capᵢ∀t=0, i∈I, s∈S (23)

Formulas (24-26) represent constraints on the maximum number of in-service vehicles at V2G nodes. Due to limitations of V2G service station capacity and transformer power, the number of EVs to be charged and the number of EVs to be discharged at the same node are both limited. Formula (24) defines the maximum number of in-service EVs to be charged simultaneously at node m; formula (25) defines the maximum number of in-service EVs to be discharged simultaneously at node m, and formula (26) defines that the number of in-service EVs to be charged and discharged simultaneously at node m is less than the number of the charging and discharging piles, where αₘ, and βₘ represent the maximum number of EVs to be charged and the maximum number of EVs to be discharged within a time period at each V2G service station, respectively.

$$\\ \begin{matrix}{\sum }_{i ∈ {I}_{m}} {μ}_{it}^{{}^{} c} \leq {α}_{m} ∀ m ∈ M , t ∈ T , i ∈ I & ( 24 )\end{matrix}$$

$$\\ \begin{matrix}{\sum }_{i ∈ {I}_{m}} {μ}_{it}^{{}^{} d} \leq {β}_{m} ∀ m ∈ M , t ∈ T , i ∈ I & ( 25 )\end{matrix}$$

$$\\ \begin{matrix}{\sum }_{i ∈ {I}_{m}} {μ}_{it}^{{}^{} c} + {\sum }_{i ∈ {I}_{m}} {μ}_{it}^{{}^{} d} \leq {Plies}_{m} ∀ m ∈ M , t ∈ T , i ∈ I & ( 26 )\end{matrix}$$

Formulas (27-28) represent constraints on the charging and discharging capacities of EVs. During the charging and discharging process of an EV, actual charging or discharging capacities are limited by a real-time SOC. When μᵢₜ^{c} and μᵢₜ^{d} are both 0, the charging capacity eᵢₜ^{c,s} and the discharging capacity eᵢₜ^{d,s} of EVᵢ at time period t are constrained to; and when μᵢₜ^{c}=1 or μᵢₜ^{d}=1, the charging capacity eᵢₜ^{c,s} and the discharging capacity eᵢₜ^{d,s} of EVᵢ are constrained by maximum schedulable capacity values of the battery (SOCᵢ^{max}−sᵢₜ^{s})Capᵢ and (sᵢₜ^{s}−SOCᵢ^{min})Capᵢ, respectively.

0≤eᵢₜ^{c,s}≤(SOCᵢ^{max}−sᵢₜ^{s})Capᵢμᵢₜ^{c}∀i∈I, t∈T, s∈S (27)

0≤eᵢₜ^{d,s}≤(sᵢₜ^{s}−SOCᵢ^{min})Capᵢμᵢₜ^{d}∀i∈I, t∈T, s∈S (28)

Formulas (29-30) represent SOC constraints of EVs: a change range of battery SOCs of in-scheduling agreement EVs is given; formula (29) represents an optimal battery operating range of an EV involved in V2G, and formula (30) represents that the SOC of the EV needs to meet an expected value of a user after the service ends, and the charging and discharging dispatch is carried out on the premise of meeting a coming travel need of the user, where T_{end} is set to the dispatch end time.

SOCᵢ^{min} ≤sᵢₜ^{s}≤SOCᵢ^{max}∀i∈I, t∈T, s∈S (29)

SOCᵢ^{umin} ≤sᵢₜ^{s}∀i∈I, t∈T_{end}, s∈S (30)

Formula (31) represents a power balance constraint of EV's batteries. A power of EVᵢ at time period t is equal to a residual power at time period t−1 plus a power difference between a charging operation and a discharging operation at time period t.

eᵢₜ^{s}=eᵢₜ₋₁^{s}+eᵢₜ^{c,s}−eᵢₜ^{d,s}∀i∈I, t∈T, s∈S (31)

Formulas (32-33) represent constraints on charging and discharging climbing of EVs: charging and discharging climbing capabilities of an EV are affected by a rated power of the charging and discharging pile and a charging way; the constraints define that battery charging and discharging capacities of an EV during each time period are not greater than the charging and discharging climbing capabilities Kᵢ^{c} and Kᵢ^{d}, so as to avoid battery damage due to charging and discharging limits. The charging and discharging climbing constraints take effect at a second stage when and only when the EV accepts a first-stage scheduling plan, where Kᵢ^{c} represents the maximum charging climbing capability, and Kᵢ^{d} represents the maximum discharging climbing capability.

eᵢₜ^{s}−eᵢₜ₋₁^{s}≤Kᵢ^{c}μᵢₜ^{c}∀i∈I, t∈T, s∈S (32)

eᵢₜ₋₁^{s}−eᵢₜ^{s}≤Kᵢ^{d}μᵢₜ^{d}∀i∈I, t∈T, s∈S (33)

Formulas (34-35) represent the maximum V2G service capacity constraints at nodes. Formula (35) is used to calculate a total charging demand of out-of-agreement EVs arriving randomly. Formula (34) represents a capacity of an in-agreement EV participating in charging dispatch, which is random due to the influences of a number of out-of-agreement EVs and their charging demands in formula (35), where Zₘ^{s,t} represents a number of the out-of-agreement EVs arriving randomly, and Eₘₜ^{cmax} represents a rated charging capacity provided at node m.

$$\\ \begin{matrix}0 \leq {\sum }_{i ∈ {I}_{m}} {e}_{it}^{{}^{} c , s} \leq {E}_{mt}^{{}^{} cmax} - {E}_{mt}^{{}^{} cNonV 2 G} ∀ t ∈ T , m ∈ M , s ∈ S & ( 34 )\end{matrix}$$

$$\\ \begin{matrix}where : {E}_{mt}^{{}^{} cNonV 2 G} = {Z}_{m}^{{}^{} s , t} {I}_{c} {P}_{NonV 2 G}^{{}^{} c} Δ t ∀ t ∈ T , m ∈ M , s ∈ S & ( 35 )\end{matrix}$$

Formulas (36-37) represent constraints on power balance of network nodes: an energy transmission network is established by a model, and power balance of network nodes meets Kirchhoff s law; formula (36) limits a maximum capacity of a bidirectional energy flow and specifies that power transmission is within a standard; and after Pₘₜ^{r,s} is introduced to describe the randomness of wind and solar power generation, formula (37) establishes an energy balance constraint for each node, thereby ensuring that a total inflow power is equal to a total outflow power at each node.

$$\\ \begin{matrix}- Line . {}^{} {Cap}_{l} \leq {f}_{lt}^{{}^{} s} \leq Line . {}^{} {Cap}_{l} ∀ t ∈ T l ∈ L , s ∈ S & ( 36 )\end{matrix}$$

$$\\ \begin{matrix}\\ {P}_{mt}^{{}^{} load , s} + {\sum }_{l ∈ {A}_{m}^{-}} {f}_{lt}^{{}^{} out , s} + {p}_{mt}^{{}^{} AG , s} + {\sum }_{i ∈ {I}_{m}} {e}_{it}^{{}^{} c , s} + {E}_{mt}^{{}^{} cNonV 2 G} = {\sum }_{l ∈ {A}_{m}^{+}} {f}_{lt}^{{}^{} in , s} + {p}_{mt}^{{}^{} B 1 , s} + {P}_{mt}^{{}^{} r , s} + {\sum }_{i ∈ {I}_{m}} {e}_{it}^{{}^{} d , s} + {p}_{mt}^{{}^{} B 2 , s} & ( 37 )\end{matrix}$$

$$\\ ∀ t ∈ T , i ∈ I , m ∈ M , s ∈ S$$

Linearization of nonlinear constraints:

Since there are nonlinear terms in constraint condition formulas (27) and (28), formula (27) is transformed into formulas (38) to (40), and similarly, formula (28) is transformed into formulas (41) to (43), in order to improve the model solution quality and computational speed, where

0≤eᵢₜ^{c,s}≤SOCᵢ^{max}Capᵢμᵢₜ^{c}−Capᵢφᵢₜ^{s}∀i∈I, t∈T, s∈S (38)

0≤φᵢₜ^{s}≤sᵢₜ^{s}∀i∈I, t∈T, s∈S (39)

sᵢₜ^{s}−SOCᵢ^{max}(1−μᵢₜ^{c})≤φᵢₜ^{s}≤SOCᵢ^{max}μᵢₜ^{c}∀i∈I, t∈T, s∈S (40)

0≤eᵢₜ^{d,s}≤CAPᵢχᵢₜ^{s}−SOCᵢ^{min}Capᵢμᵢₜ^{d}∀i∈I, t∈T, s∈S (41)

0≤χᵢₜ^{s}≤sᵢₜ^{s}∀i∈I, t∈T, s∈S (42)

sᵢₜ^{s}−SOCᵢ^{max}(1−μᵢₜ^{d})≤χᵢₜ^{s}≤SOCᵢ^{max}μᵢₜ^{d}∀i∈I, t∈T, s∈S (43)

Based on the above objectives and constraints, a two-stage stochastic optimization model based on wind and solar power generation randomness and V2G resource randomness is established below.

### Maxmize F(5)

### Subject to:

### First-stage Constraints:(10) to (21)

Charging and discharging exclusive constraint (10)
Charging status constraints (11) to (14)
Discharging status constraints (15) to (18)
Constraints on maximum charging and discharging switching times (19) to (21)

### Second-stage Constraints:(22) to (43)

Initial state constraints of EVs when they are connected to the grid (22) to (23)
Constraints on the maximum number of V2G in-services at nodes (24) to (26)
EV charging and discharging power constraints (27) to (28)
Linearization of EV charging and discharging energy constraints (38) to (43)
SOC constraints of EVs (29) to (30)
Power balance constraint of EVs (31)
EV charging and discharging climbing constraints (32) to (33)
Maximum capacity constraints of V2G nodes (34) to (35)
Network node capacity and balance constraints (36) to (37)

Optimization results of the model are described in detail below in combination with specific examples.

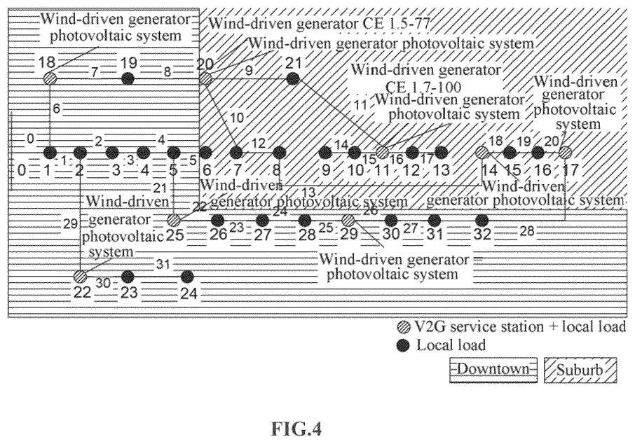

In the context of an area governed by a V2G operator in combination with a power trading mechanism of a renewable energy power generation system, a standard power distribution network topology of IEEE-33 nodes is selected for illustration, and installed wind-driven power generators and photovoltaic power generation systems are pre-mounted at part of selected nodes. The topology is shown in FIG. 4.

To verify the optimization effect of the model, the following parameters are firstly designed. There are 8 V2G nodes and 100 in-agreement EVs for ordered charging and discharging. The vehicle models and some parameters are as shown in Table 4:

TABLE 4
Parameters of EVs involved in Scheduling

| Vehicle | Capᵢ | ESᵢ | Kᵢ^{c} | Kᵢ^{d} | Lᵢ^{cmin} | Lᵢ^{dmin} |
|---|---|---|---|---|---|---|
| Model | kwh | kWh/100 km | kW | kW | h | h |
| 1 | 60 | 12 | 30 | 20 | 2 | 2 |
| 2 | 80 | 16 | 30 | 20 | 2 | 2 |
| 3 | 100 | 20 | 30 | 20 | 2 | 2 |
| 4 | 120 | 24 | 30 | 20 | 2 | 2 |

A single GE1.5-77 wind-driven power generator and a GE1.7-100 high-power wind-driven power generator are arranged at node 20 and node 11, respectively, and other V2G service stations are equipped with small wind-power photovoltaic systems. Specific parameters of the wind-driven generators are shown in Table 5. Random wind power parameters are generated by step 2.

TABLE 5
Parameters of Wind-Driven Power Generators

| | Cut-in | Rated | Cut-out | Rated |
|---|---|---|---|---|
| | speed | speed | speed | power |
| Name | (m/s) | (m/s) | (m/s) | (kw) |
| GE1.5-77 | 3.5 | 14 | 25 | 1500 |
| GE1.7-100 | 3 | 11 | 25 | 1700 |
| Small wind- | 5 | 10 | 15 | 150 |
| driven | | | | |
| generator | | | | |

For the in-agreement EVs, a predetermined target SOC at the end of scheduling is 0.8. The charging power of the out-of-agreement EVs arriving randomly is set to 40 kW.

A multi-variable combined scenario is generated, and SC^{D} is set to 4, SC^{Z} to 5, SC^{WT} to 5, and SC^{PV} to 2. SC^{F}=200 final scenarios are generated through scenario combination. A branch-and-bound algorithm of Gurobi solver is invoked in Python environment to solve the model.

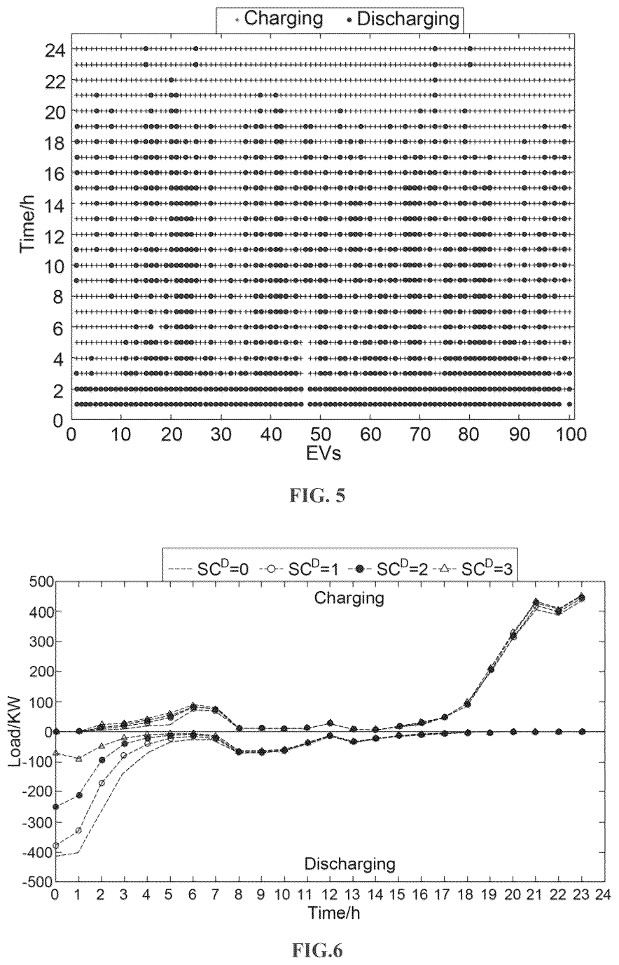

FIG. 5 depicts a charging and discharging decision diagram for EVs under the constraints of the shortest charging and discharging time. It shows the extensive involvement of in-agreement EVs in the daily scheduling of charging and discharging, and the manner of being involved in scheduling complies with the constraints of the model. A significant proportion of the total time period is dedicated to the scheduling of a cluster of EVs, approaching nearly 100%, which proves that the scheduling model effectively controls the charging and discharging states of the in-agreement EVs and satisfy the objective of maximizing the service revenue of the scheduling center. The cluster of in-agreement EVs would be standby all day and keep a grid-connected state. The time period between 0:00-2:00 a.m. represents a concentrated period for EV discharging. Given the relatively low discharging prices during this window, the scheduling center strategically coordinates the discharging of in-agreement EVs to meet the demands of other loads, thereby maximizing the scheduling revenue.

FIG. 6 illustrates the impact of the random travel distance parameter DP of EVs prior to grid connection on charging and discharging loads. The scheduling of in-agreement EVs is governed by the interplay between supply and demand, with discharging primarily concentrated between 0:00-5:00 a.m. and 8:00-10:00 a.m. The random parameter Di exerts influence on the discharging load during the 0:00-5:00 a.m. period, wherein a higher mean value of day-ahead travel distances corresponds to a lower state of charge (SOC) at the time of connection and subsequently reduced load involvement in discharging. Conversely, the discharging load between 8:00-10:00 a.m. remains unaffected by the random parameter Di , as its influence is solely confined to the initial SOCs of EVs. Following charging between 5:00-7:00 a.m., the impact of the random parameter Di has been eliminated. Notably, during the time period of 17:00-23:00 p.m., achieving the target SOC of 0.8 by the end of the scheduling day may result in a substantial increase in the charging load of EVs.

The optimal results of the objective function presented in Table 6 indicate that with 100 EVs on schedule, the expected revenue of the scheduling center for the given day is 69323.4 Yuan. The revenue from EV charging amounts to 12359.5 Yuan, while the discharging cost of the scheduled EVs is 3388.9 Yuan, resulting in a net revenue of 8970.6 Yuan for this dispatch. The profit from the V2G service constitutes 13% of the total profit. The primary source of profit for the scheduling center is derived from the power consumption by local loads, with renewable energy predominantly utilized for electrical loads and EVs within the local area, thereby enabling the scheduling center to generate substantial revenue.

TABLE 6
Energy Scheduling Revenue of Objective Function

| | Revenue | Cost | Profit |
|---|---|---|---|
| In-agreement EVs | 12359.5 | 3388.9 | 8970.6 |
| V2G node load | 39456.0 | 44761.7 | −5305.7 |
| Non-V2G node load | 162300.0 | 89131.3 | 73168.7 |
| Renewable energy power | — | 9018.0 | −9018.0 |
| generation | | | |
| Surplus power fed into | 1507.8 | — | 1507.8 |
| the grid | | | |
| Total | 215623.3 | 146299.9 | 69323.4 |

In this specification, descriptions of reference terms such as “one embodiment”, “some embodiments”, “an example”, “a specific example”, or “some examples” indicate that specific features, structures, materials, or features described in combination with the embodiment(s) or example(s) are included in at least one embodiment or example of the present disclosure. In this specification, the schematic expression of the above terms is not necessarily directed to the same embodiment or example. Moreover, the specific features, structures, materials, or features described may be combined in a suitable manner in any one or more embodiments or examples. In addition, those skilled in the art may combine different embodiments or examples described in this specification and features of the different embodiments or examples without mutual contradiction.

The above embodiments are only intended for explaining technical concept and features of the present disclosure, and are intended to enable those of ordinary skill in the art to understand and implement the content of the present disclosure and implement therefrom, but are not intended to limit the protection scope of the present disclosure. Any equivalent changes or modifications made according to the essence of the contents of the present disclosure shall fall within the protection scope of the present disclosure.

What is claimed is:

1. A two-stage stochastic programming based vehicle-to-grid (V2G) scheduling method for maximizing operator revenue, which is used for an energy system comprising electric vehicles (EVs), charging and discharging stations, and a power grid, the method comprising:
obtaining a day-ahead parameter set of EVs within an operator's service area, issuing scheduling invitation agreements to EVs within the service area, and classifying EVs accepting the scheduling invitation agreements as in-agreement EVs and EVs not responding to or refusing the scheduling invitation agreements as out-of-agreement EVs;
establishing a random scenario set based on the day-ahead parameter set of EVs within the service area, conditions of the in-agreement EVs and the out-of-agreement EVs, wherein when a predetermined random charging demand for the out-of-agreement EVs is met, optimal charging and discharging scheduling of the in-agreement EVs is performed;
in consideration of random factors being independent of one another, establishing a final random scenario combining a V2G scheduling resource and renewable energy power generation, and establishing a V2G two-stage nonlinear stochastic programming model based on the final random scenario; and
maximizing a total revenue of a V2G operator by using the V2G two-stage nonlinear stochastic programming model.

2. The method according to claim 1, wherein the established random scenario set comprises a random scenario of the V2G scheduling resource; the random scenario of the V2G scheduling resource comprises one or more of a random scenario of an initial state of charge (SOC), a random scenario of a V2G service station resource, and a scenario of load uncertainty on a power supply side or demand side,
in the random scenario of the initial SOC, in order to show SOC randomness of the in-agreement EVs involved in scheduling, a logarithm normal distribution model (1) of day-ahead travel distances of the in-agreement EVs is used; travel distances of the in-agreement EVs before grid connection are obtained by a Monte Carlo method as a random travel distance parameter Dᵢ^{s}, and a random scenario set SC^{D} is correspondingly generated;
$$\\ \begin{matrix}{f}_{d} ( d ) = \frac{8}{5 d {σ}_{d} \sqrt{2 π}} exp \{ - \frac{{[ ln ( 5 d ) - 3 ln 2 - {μ}_{d} ]}^{2}}{2 {σ}_{d}^{{}^{} 2}} \} & ( 1. )\end{matrix}$$
in the random scenario of the V2G service station resource, in order to show randomness of available charging and discharging pile resources within the V2G service station, since the V2G service station can serve both the in-agreement EVs and the out-of-agreement EVs at the same time, a homogeneous Poisson model (2) with a constant average arrival rate is used to describe a number of out-of-agreement EVs randomly arriving; the number of out-of-agreement EVs randomly arriving at a charging and discharging station is obtained by the Monte Carlo method as a random arrival number parameter Zₘ^{s,t}; and a random scenario set SC^{Z} is correspondingly generated.
$$\\ \begin{matrix}P ( i ) = \frac{{λ}^{i} {e}^{- λ}}{i !} , ∀ i ∈ {I}_{Z} , and i ∉ I & ( 2. )\end{matrix}$$

3. The method according to claim 2, wherein the established random scenario set further comprises a random scenario of wind power generation and a random scenario of photovoltaic power generation,
in the random scenario of wind power generation, a random wind speed parameter is obtained by Latin hypercube sampling (LHS) according to a Weibull distribution model (3) of wind power generation;
$$\\ \begin{matrix}Pv ( v , k , c ) = ( k / c ) * {( v / c )}^{{}^{} k - 1} {e}^{- {( \frac{v}{c} )}^{{}^{} k - 1}} & ( 3. )\end{matrix}$$
a number of scenarios is reduced by a simultaneous backward reduction, and a wind power output scenario SC WT is generated by a wind-driven generator power fitting model; and
in the random scenario of photovoltaic power generation, historical data of daily photovoltaic power generation for one year is selected to generate a scenario pool of photovoltaic power generation; the random scenario of photovoltaic power generation is obtained by random sampling; and a random scenario SC^{PV} is generated by the simultaneous backward reduction.

4. The method according to claim 3, wherein in consideration of random factors being independent of one another, four random scenarios SC^{D}, SC^{Z}, SC^{WT}, and SC^{PV} are combined and calculated, the random scenarios are cross-combined to generate the final random scenario SC F ; formula (4) is utilized to calculate a probability of a scenario combination SC^{F};
$$\\ \begin{matrix}\begin{matrix}P ( s ) = P ( {sc}^{{}^{} D} ) P ( {sc}^{{}^{} Z} ) P ( {sc}^{{}^{} PV} ) P ( {sc}^{{}^{} WT} ) & ∀ s ∈ {SC}^{{}^{} F} , {sc}^{{}^{} D} ∈ {SC}^{{}^{} D} , \\ & {sc}^{{}^{} Z} ∈ {SC}^{{}^{} Z} , {sc}^{{}^{} PV} ∈ {SC}^{{}^{} PV} , \\ & {sc}^{{}^{} WT} ∈ {SC}^{{}^{} WT}\end{matrix} & ( 4. )\end{matrix}$$
wherein P(sc^{D}) is 1/SC^{D}, and P(sc^{Z}) is 1/SC^{Z}; and P(sc^{PV}) and P(sc^{WT}) are determined by a scenario reduction algorithm.

5. The method according to claim 4, wherein the V2G two-stage nonlinear stochastic programming model comprises an objective function, first-stage constraints, and second-stage constraints;
the objective function: an objective equation F maximizes the total revenue of the V2G operator, as shown in formula (5), formula (6) represents a total revenue (Reν_{EV}) of the operator involved in scheduling; formula (7) represents a total revenue (Reν_{AG}) of the operator coordinating power supply for a local load and surplus power fed into the grid; formula (8) represents a total cost (Cost_{B}) of the operator purchasing thermal power on a day ahead and a current day; and formula (9) represents a total cost (Cost om) of renewable energy power generation of the operator;
$$Max F = {\sum }_{i ∈ I} {\sum }_{t ∈ {T}_{i}} ( {CS}_{i} {v}_{it}^{c} + {DS}_{i} {v}_{it}^{d} ) + {\sum }_{s ∈ S} {Prob}_{s} [ ( {Rev}_{EV} + {Rev}_{AG} + {Cost}_{B} - {Cost}_{OM} ) ] \qquad ( 5. )$$
$$wherein {Rev}_{EV} = {\sum }_{i ∈ I} {\sum }_{t ∈ {T}_{i}} ( {Price}_{t}^{c} {e}_{it}^{c , s} - {Price}_{t}^{d} {e}_{it}^{d , s} ) Δ t \qquad ( 6. )$$
$${Rev}_{AG} = {\sum }_{m ∈ M} {\sum }_{t ∈ {T}_{i}} ( {C}_{t}^{AG} {p}_{mt}^{AG , s} ) Δ t + {\sum }_{m ∈ M} {\sum }_{t ∈ {T}_{i}} ( {C}_{t}^{AG 1} {p}_{mt}^{load , s} ) Δ t \qquad ( 7. )$$
$${Cost}_{B} = {\sum }_{m ∈ M} {\sum }_{t ∈ {T}_{i}} ( {C}_{t}^{AG 1} {p}_{mt}^{B 1 , s} + {C}_{t}^{AG 2} {p}_{mt}^{B 2 , s} ) Δ t \qquad ( 8. )$$
$${Cost}_{OM} = {\sum }_{m ∈ M} {\sum }_{t ∈ {T}_{i}} ( {C}^{r} {P}_{mt}^{r , s} ) Δ t \qquad ( 9. )$$
the first-stage constraints:
formula (10) represents a charging and discharging exclusion constraint of EVs: a charging operation and a discharging operation of the same EV cannot occur at the same time within a scheduling time period;
μᵢₜ^{c}+μᵢₜ^{d}≤1∀i∈I, t∈T (10)
formulas (11-14) represent constraints on charging state of EVs: an EV is connected to a power distribution network to be charged within a time period t, and a least charging duration and a least idle duration are limited to avoid frequent switching among charging, discharging, and idle states, thereby preventing battery damage of the EVs and cost increase in switching services, wherein Lᵢ^{c} represents the least charging duration, and Lᵢ^{idle} represents the least idle duration;
μᵢₜ^{c}−μᵢₜ₋₁^{c}≤μ_{iτ}^{c}∀i∈I, t∈T, τ=tᵢ, . . . , min{tᵢ+Lᵢ^{c}−1, |T|} (11)
μᵢₜ₋₁^{c}−μᵢₜ^{c}≤1−μ_{iτ}^{c}∀i∈I, t∈T, τ=tᵢ, . . . , min{tᵢ+Lᵢ^{idle}−1, |T|} (12)
vᵢₜ^{c}≥μᵢₜ^{c}−μᵢₜ₋₁^{c}∀i∈I, t∈T (13)
wᵢₜ^{c}≥−μᵢₜ^{c}+μᵢₜ₋₁^{c}∀i∈I, t∈T (14)
formulas (15-18) represent discharging state constraints of EVs to limit a shortest discharging duration and a shortest idle duration, wherein Lᵢ^{d} represents the shortest discharging duration;
μᵢₜ^{d}−μᵢₜ₋₁^{d}≤μ_{iτ}^{d}∀i∈I, t∈T, τ=tᵢ, . . . , min{tᵢ+Lᵢ^{d}−1, |T|} (15)
μᵢₜ₋₁^{d}−μᵢₜ^{d}≤1−μ_{iτ}^{d}∀∀i∈I, t∈T, τ=tᵢ, . . . , min{tᵢ+Lᵢ^{idle}−1, |T|} (16)
vᵢₜ^{d}≥μᵢₜ^{d}−μᵢₜ₋₁^{d}∀i∈I, t∈T (17)
wᵢₜ^{d}≥−μᵢₜ^{d}+μᵢₜ₋₁^{d}∀i∈I, t∈T (18)
formulas (19-21) represent constraints on a maximum number of charging and discharging switching times for EVs, to limit a maximum number of charging and discharging switching times of EVs within a day, and limitation of a maximum number of switchable states of an EV in a day effectively prevent excessively frequent transitions between charging and discharging states, wherein Nᵢ^{c} and Nᵢ^{d} represent upper limits of charging times and discharging times of an EV in a V2G scheduling plan, restrictively, and Vᵢ represents an upper limit of charging and discharging switching times;
$$\\ \begin{matrix}{\sum }_{t ∈ {T}_{i}} {v}_{it}^{{}^{} c} \leq {N}_{i}^{{}^{} c} ∀ i ∈ I , t ∈ T & ( 19 )\end{matrix}$$
$$\\ \begin{matrix}{\sum }_{t ∈ {T}_{i}} {v}_{it}^{{}^{} d} \leq {N}_{i}^{{}^{} d} ∀ i ∈ I , t ∈ T & ( 20 )\end{matrix}$$
$$\\ \begin{matrix}{\sum }_{t ∈ {T}_{i}} {v}_{it}^{{}^{} c} + {\sum }_{t ∈ {T}_{i}} {v}_{it}^{{}^{} d} \leq {V}_{i} ∀ i ∈ I , t ∈ T & ( 21 )\end{matrix}$$
the second-stage constraints:
formulas (22-23) represent initial state constraints of EVs during grid connection: formula (22) is used to calculate an initial power of an EV when grid connection based on a travel distance of the EV before grid connection and participating in scheduling; formula (23) is used to calculate an initial SOC of EVᵢ, and randomness of travel distances results in randomness of initial SOCs of an EV cluster, wherein Dᵢ^{s} represents a random parameter of the travel distance of in-agreement EVᵢ before grid connection;
eᵢₜ^{s}=Capᵢ−Dᵢ^{s}Esᵢ/100∀t=0, i∈I, s∈S (22)
sᵢₜ^{s}=e_{i,t}^{s}/Capᵢ∀t=0, i∈I, s∈S (23)
formulas (24-26) represent constraints on a maximum number of in-service vehicles at V2G nodes: due to limitations of V2G service station capacity and transformer power, a number of EVs to be charged and a number of EVs to be discharged at the same node are both limited; formula (24) defines a maximum number of in-service EVs to be charged simultaneously at node m; formula (25) defines a maximum number of in-service EVs to be discharged simultaneously at node m, and formula (26) defines that a number of in-service EVs to be charged and discharged simultaneously at node m is less than a number of the charging and discharging piles, wherein αₘ, and βₘ represent a maximum number of EVs to be charged and a maximum number of EVs to be discharged within a time period at each V2G service station, respectively;
$$\\ \begin{matrix}{\sum }_{i ∈ {I}_{m}} {μ}_{it}^{{}^{} c} \leq {α}_{m} ∀ m ∈ M , t ∈ T , i ∈ I & ( 24 )\end{matrix}$$
$$\\ \begin{matrix}{\sum }_{i ∈ {I}_{m}} {μ}_{it}^{{}^{} d} \leq {β}_{m} ∀ m ∈ M , t ∈ T , i ∈ I & ( 25 )\end{matrix}$$
$$\\ \begin{matrix}{\sum }_{i ∈ {I}_{m}} {μ}_{it}^{{}^{} c} + {\sum }_{i ∈ {I}_{m}} {μ}_{it}^{{}^{} d} \leq {Plies}_{m} ∀ m ∈ M , t ∈ T , i ∈ I & ( 26 )\end{matrix}$$
formulas (27-28) represent charging and discharging capacity constraints of EVs: during charging and discharging of EVs, actual charging or discharging capacities are limited by a real-time SOC, wherein when μᵢₜ^{c} and μᵢₜ^{d} are both 0, charging capacity eᵢₜ^{c,s} and discharging capacity eᵢₜ^{d,s} of EVᵢ at time period t are constrained to 0; and when μᵢₜ^{c}=1 or μᵢₜ^{d}=1, charging capacity eᵢₜ^{c,s} and discharging capacity eᵢₜ^{d,s} of EVᵢ are respectively constrained by maximum schedulable battery capacity values (SOCᵢ^{max}−sᵢₜ^{s})Capᵢ and (sᵢₜ^{s}−SOCᵢ^{min})Capᵢ;
0≤eᵢₜ^{c,s}≤(SOCᵢ^{max}−sᵢₜ^{s})Capᵢμᵢₜ^{c}∀i∈I, t∈T, s∈S (27)
0≤eᵢₜ^{d,s}≤(sᵢₜ^{s}−SOCᵢ^{min})Capᵢμᵢₜ^{d}∀i∈I, t∈T, s∈S (28)
formulas (29-30) represent SOC constraints of EVs: a change range of battery SOCs of the in-agreement EVs is given; formula (29) represents an optimal battery operating range of an EV involved in V2G, and formula (30) represents that an SOC of an EV meets an expected value of a user after service ends, and charging and discharging dispatch is carried out on the premise of meeting a coming travel demand of the user, wherein T_{end} is set to a dispatch end time;
SOCᵢ^{min} ≤sᵢₜ^{s}≤SOCᵢ^{max}∀i∈I, t∈T, s∈S (29)
SOCᵢ^{umin} ≤sᵢₜ^{s}∀i∈I, t∈T_{end}, s∈S (30)
formula (31) represents a power balance constraint of EV batteries: a power of EVᵢ at time period t is equal to a residual power at time period t−1 plus a power difference between a charging operation and a discharging operation at time period t;
eᵢₜ^{s}=eᵢₜ₋₁^{s}+eᵢₜ^{c,s}−eᵢₜ^{d,s}∀i∈I, t∈T, s∈S (31)
formulas (32-33) represent constraints on charging and discharging climbing of EVs: charging and discharging climbing capabilities of an EV are affected by a rated power of the charging and discharging pile and a charging way; the constraints define that battery charging and discharging capacities of an EV during each time period are not greater than charging and discharging climbing capabilities Kᵢ^{c} and Kᵢ^{d}, so as to avoid battery damage due to charging and discharging limits; and the charging and discharging climbing constraints take effect at a second stage when and only when the EV accepts a first-stage scheduling plan, wherein Kᵢ^{c} represents a maximum charging climbing capability, and Kᵢ^{d} represents a maximum discharging climbing capability;
eᵢₜ^{s}−eᵢₜ₋₁^{s}≤Kᵢ^{c}μᵢₜ^{c}∀i∈I, t∈T, s∈S (32)
eᵢₜ₋₁^{s}−eᵢₜ^{s}≤Kᵢ^{d}μᵢₜ^{d}∀i∈I, t∈T, s∈S (33)
formulas (34-35) represent maximum V2G service capacity constraints at nodes: formula (35) is used to calculate a total charging demand of out-of-agreement EVs arriving randomly; formula (34) represents a capacity of an in-agreement EV participating in charging dispatch, which is random due to influences of a number of out-of-agreement EVs and their charging demands in formula (35), wherein Z in st represents a number of the out-of-agreement EVs arriving randomly, and E m cn i lax represents a rated charging capacity provided at node m;
$$\\ \begin{matrix}0 \leq {\sum }_{i ∈ {I}_{m}} {e}_{it}^{{}^{} c , s} \leq {E}_{mt}^{{}^{} cmax} - {E}_{mt}^{{}^{} cNonV 2 G} ∀ t ∈ T , m ∈ M , s ∈ S & ( 34 )\end{matrix}$$
$$\\ \begin{matrix}where : {E}_{mt}^{{}^{} cNonV 2 G} = {Z}_{m}^{{}^{} s , t} {I}_{c} {P}_{NonV 2 G}^{{}^{} c} Δ t ∀ t ∈ T , m ∈ M , s ∈ S & ( 35 )\end{matrix}$$
formulas (36-37) represent constraints on power balance of network nodes: an energy transmission network is established by a model, and power balance of network nodes meets Kirchhoff s law; formula (36) limits a maximum capacity of a bidirectional energy flow and specifies that power transmission is within a standard; and after Pₘₜ^{r,s} is introduced to describe randomness of wind and solar power generation, formula (37) establishes an energy balance constraint for each node, thereby ensuring that a total inflow power is equal to a total outflow power at each node;
$$\\ \begin{matrix}- Line . {}^{} {Cap}_{l} \leq {f}_{lt}^{{}^{} s} \leq Line . {}^{} {Cap}_{l} ∀ t ∈ T l ∈ L , s ∈ S & ( 36 )\end{matrix}$$
$$\\ \begin{matrix}\\ {P}_{mt}^{{}^{} load , s} + {\sum }_{l ∈ {A}_{m}^{-}} {f}_{lt}^{{}^{} out , s} + {p}_{mt}^{{}^{} AG , s} + {\sum }_{i ∈ {I}_{m}} {e}_{it}^{{}^{} c , s} + {E}_{mt}^{{}^{} cNonV 2 G} = {\sum }_{l ∈ {A}_{m}^{+}} {f}_{lt}^{{}^{} in , s} + {p}_{mt}^{{}^{} B 1 , s} + {P}_{mt}^{{}^{} r , s} + {\sum }_{i ∈ {I}_{m}} {e}_{it}^{{}^{} d , s} + {p}_{mt}^{{}^{} B 2 , s} & ( 37 )\end{matrix}$$
$$\\ ∀ t ∈ T , i ∈ I , m ∈ M , s ∈ S$$
linearization of nonlinear constraints:
since constraint formulas (27) and (28) both have nonlinear terms, formula (27) is transformed into formulas (38) to (40), and formula (28) is transformed into formulas (41) to (43), in order to improve model solution quality and computational speed, wherein
0≤eᵢₜ^{c,s}≤SOCᵢ^{max}Capᵢμᵢₜ^{c}−Capᵢφᵢₜ^{s}∀i∈I, t∈T, s∈S (38)
0≤φᵢₜ^{s}≤sᵢₜ^{s}∀i∈I, t∈T, s∈S (39)
sᵢₜ^{s}−SOCᵢ^{max}(1−μᵢₜ^{c})≤φᵢₜ^{s}≤SOCᵢ^{max}μᵢₜ^{c}∀i∈I, t∈T, s∈S (40)
0≤eᵢₜ^{d,s}≤CAPᵢχᵢₜ^{s}−SOCᵢ^{min}Capᵢμᵢₜ^{d}∀i∈I, t∈T, s∈S (41)
0≤χᵢₜ^{s}≤sᵢₜ^{s}∀i∈I, t∈T, s∈S (42)
sᵢₜ^{s}−SOCᵢ^{max}(1−μᵢₜ^{d})≤χᵢₜ^{s}≤SOCᵢ^{max}μᵢₜ^{d}∀i∈I, t∈T, s∈S (43)
